(19) United States
(12) Patent Application Publication
(10) Pub. No.: US 2004/0089768 A1
(43) Pub. Date: May 13, 2004

(54) Assembly for fastening line devices

(76) Inventors: Helmut Kadrnoska, Wien (AT); Gerhard Reiss, Wien (AT)

Correspondence Address: LERNER AND GREENBERG, P.A., POST OFFICE BOX 2480, HOLLYWOOD, FL, 33022-2480, US

(21) Appl. No.: 10/628,718

(22) Filed: Jul. 28, 2003

Related U.S. Application Data
(63) Continuation of application No. PCT/AT02/00033, filed on Jan. 25, 2002.

(30) Foreign Application Priority Data
Jan. 26, 2001 (AT) A 134/2001

(51) Int. Cl. F16L 3/22

(52) U.S. Cl. 248/68.1; 174/97

(57) ABSTRACT

The assembly allows lines such as pipes, hoses, cables, or the like to be fastened to walls of structures, for instance the interior walls of sewers. The assembly has a duct for receiving the lines and it is formed with an opening on the side that faces the wall of the structure. The duct can be fixed to the wall with devises that are fastenable to the wall at intervals in the longitudinal direction of the duct. The devises surround the duct on the remaining sides, they are provided with protruding fastening flanges, and they are formed of two parts that can be pivoted and/or shifted relative to one another.

### CROSS-REFERENCE TO RELATED APPLICATION

This application is a continuation of copending International Application No. PCT/AT02/00033, filed Jan. 25, 2002, which designated the United States and which was not published in English.

### BACKGROUND OF THE INVENTION

Field of the Invention

The invention lies in the mechanical arts. More specifically, the invention pertains to a device for fastening lines such as pipes, hoses, cables, or the like, to walls of structures such as sewers, with a duct for receiving the lines which is fastened to the wall of the structure.

According to prior art methods, sewers that run beneath the surface of the streets are already utilized for laying lines so that excavation work can be avoided. Cable cups with an upward U-shaped cross-section are utilized for laying these lines. The cups are fastened to the wall of the sewer with one leg of the U. The disadvantage of that construction is that the lines laid therein are not sufficiently protected, and debris and flotsam that is carried with the sewage wastewater can become lodged in the cable cups and damage the lines.

### SUMMARY OF THE INVENTION

It is accordingly an object of the invention to provide an assembly for fastening line devices which overcomes the above-mentioned disadvantages of the heretofore-known devices and methods of this general type and which provides for a device that can be easily mounted and which guarantees sufficient protection of the lines against the floating debris carried by the sewage wastewater.

With the foregoing and other objects in view there is provided, in accordance with the invention, an assembly for fastening line material on a wall, such as pipes, hoses, and cables to be mounted on interior sewer walls. The assembly comprises:

a duct for receiving the line material, the duct having an opening on a side facing the wall and remaining sides;

a plurality of devises for fastening the duct to the wall disposed at intervals in a longitudinal direction of the duct, the devises surrounding the duct on the remaining sides of the duct; and

the devises having protruding fastening flanges and including at least two interconnected parts joined to one another to enable the parts to be pivoted and/or shifted relative to one another.

In other words, as a solution to the above problems, the invention provides that the duct includes an opening for inserting lines on a side facing the wall of the structure, and that mounting devises are provided at intervals in the longitudinal direction of the duct, which surround the duct at the remaining sides and which are provided with protruding fastening angles or flanges. In the utilization of the inventive device, the whole of the lines are received by the duct, these being inserted into the duct by way of the opening, which is sealed by the wall of the structure which the side of the duct containing said opening faces. The mounting clevises, which are configured at intervals and fastened by means of the protruding flanges, secure the fixing of the duct to the wall of the structure.

The duct advantageously comprises a U-shaped cross section with the ends of the legs potentially curved inward. These leg ends exert a tensile force on the lines that are received by the duct, whereby these lines are held in position in the duct.

In the simplest case, the fastening flanges can be connected directly to the wall of the structure. But it is also expedient to provide a base plate which is disposed on or can be fastened to the wall of the structure and to which the fastening flanges are detachably fastened. In this embodiment, the base plate can be fixed to the wall of the structure at predetermined intervals. To that end, threaded bars that protrude from the wall are joggled into the wall, or the base plate is screwed to the wall. The lines are then laid in the duct, which is then fixed by fastening the devises surrounding it to the base plate by means of the fastening flanges of the devises. Bolts, particularly screw bolts, that protrude from the base plate and penetrate the fastening flanges can be provided for this purpose.

According to another feature of the invention, the devises can consist of two parts that are joined to one another. These parts can be detachably joined to one another by means of a screw connection. One part advantageously bears a rivet that runs through a recess in the other part, so that this part pivots about the rivet.

It is expedient when, according to another feature of the invention, the two parts are joined in pivoting fashion, with the pivot axis running substantially perpendicular to the longitudinal direction of the duct. The advantage of such a construction is that, after loosening the fastening of the clevis to the wall of the structure or to the base plate, it is possible, by undoing the connection between the two parts or pivoting one part relative to the other and/or bending the clevis away from the wall of the duct, to raise the duct, or rather one of the sides thereof, from the wall of the structure far enough that additional lines can be laid by way of the opening.

It is also advantageous when the side of the U-shaped duct that faces the wall of the structure is provided with additional legs or extensions that extend from the ends of the legs toward the middle of the side, whereby the opening between the ends of said extensions is kept clear for inserting the lines or snapping the duct onto lines that have already been laid. The lines are fixed in the duct by these legs exerting a tensile force on the lines, so that the unwanted escape of individual lines from the opening during assembly is prevented. These legs reinforce the duct.

The duct advantageously consists of several portions which are joined by sliding sockets, which can either be formed at one end of the duct or realized as separate sockets that can be slid over abutting ends of the duct. But there may also be butt joints between the portions.

The duct advantageously has a polygonal (e.g. trapezoidal, but preferably rectangular) cross-section, but can also have some other polygonal shape in order to fit the cross-section to the lines that are to be laid. The surface of the duct facing the wall is absent or includes the opening for laying the lines.

Because these lines typically have a round cross-section, it is advantageous for reasons of space and stability when the duct has rounded and/or beveled corners. A duct can accept any number of lines, e.g. four, five, six, eight, or more.

Other features which are considered as characteristic for the invention are set forth in the appended claims.

Although the invention is illustrated and described herein as embodied in a device for fastening lines, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a plan view onto the device according to the invention;

FIG. 2 is a section taken along the line II-II in FIG. 1;

FIG. 3 is a sectional view of a modified embodiment of the duct according to the invention;

FIG. 4 is a view of the detail IV in FIG. 3, representing a variant of the construction;

FIG. 5 is a view of the detail IV in FIG. 3, representing a further variant of the construction; and

FIG. 6 is a partial, exploded, perspective view illustrating an embodiment for connecting the two portions of a clevis.

### DESCRIPTION OF THE PREFERRED EMBODIMENTS

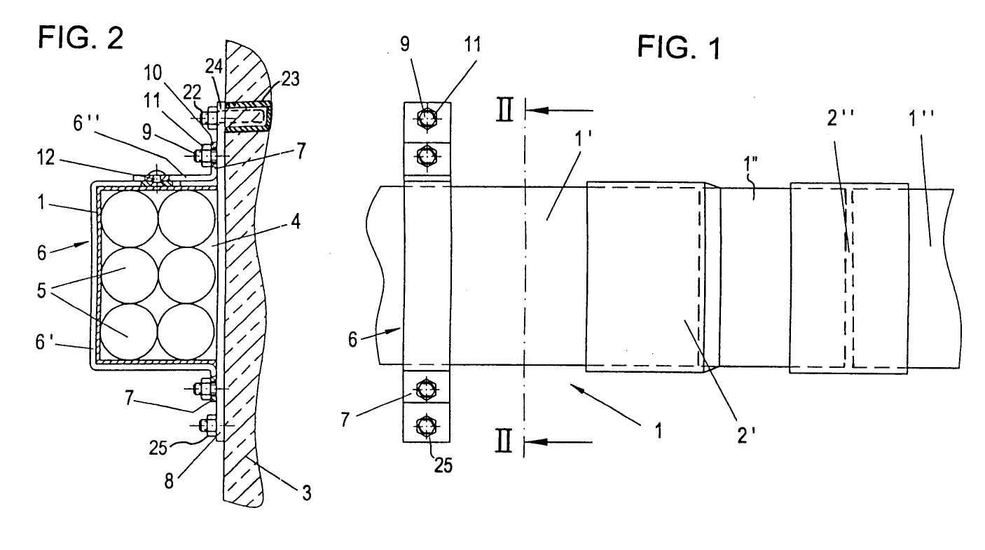

Referring now to the figures of the drawing in detail and first, particularly, to FIGS. 1 and 2 thereof, there is shown an assembly according to the invention for fastening elongated structures, such as pipes, hoses, cables, and the like. The assembly comprises a duct 1 which is composed of individual segments 1′, 1″, 1′″, which are connected to each other by a socket, namely either the socket 2′ that is formed at the duct, which is represented on the left side of FIG. 1, or by a separate sliding socket 2″. The duct 1 is laid at a wall 3, for instance a sewer wall, and includes an opening on the side adjoining this wall 3, by way of which the lines 5 can be inserted into the duct 1. For fastening the duct 1, devises 6—also referred to as straps, brackets, or yokes—are disposed at intervals and provided with outwardly protruding flanges 7 which are connected to a base plate 8 that is screwed to the wall 3. Joining is achieved by means of screw bolts 9, which protrude from the base plate 8 and penetrate holes 10 in the flanges 7, and nuts 11 that are screwed onto these screw bolts 9.

The clevis 6 consists of two parts 6′, 6″, which are joined in pivoting fashion by a bolt 12 that extends substantially perpendicular to the longitudinal direction of the duct. With this configuration, it is possible, after removing the nut 11 that fixes the part 6″ of the clevis 6 and loosening the bottom nut 11 and/or bending the clevis 6 away from the wall 3 as warranted, to pivot the part 6″ of the clevis 6 and move the duct 1 far enough from the wall 3 to be able to insert additional lines 5 into this duct 1. The clevis 6 and the duct 1 do not have to be removed from the wall.

The duct 1 advantageously consists of plastic, specifically PVC, whereas the clevis 6 consists of rustproof stainless steel.

A threaded bar with (wing) nuts can be borne by part 6′ instead of the bolt 12. The part 6″ can be installed with its recess on the threaded bar and fastened with the (wing) nut.

The cross-section of the duct 1 is advantageously dimensioned such that the lines 5 that are to be received by this duct can be accommodated in this duct without play. The duct 1 represented in the drawing has a rectangular cross-section, but it is also possible to provide other cross-sectional shapes, particularly other polygonal shapes, in order to fit the cross-section to the lines 5 that are to be laid, which have a different diameter. The devises 8 are fitted to the outer contour of the duct 1.

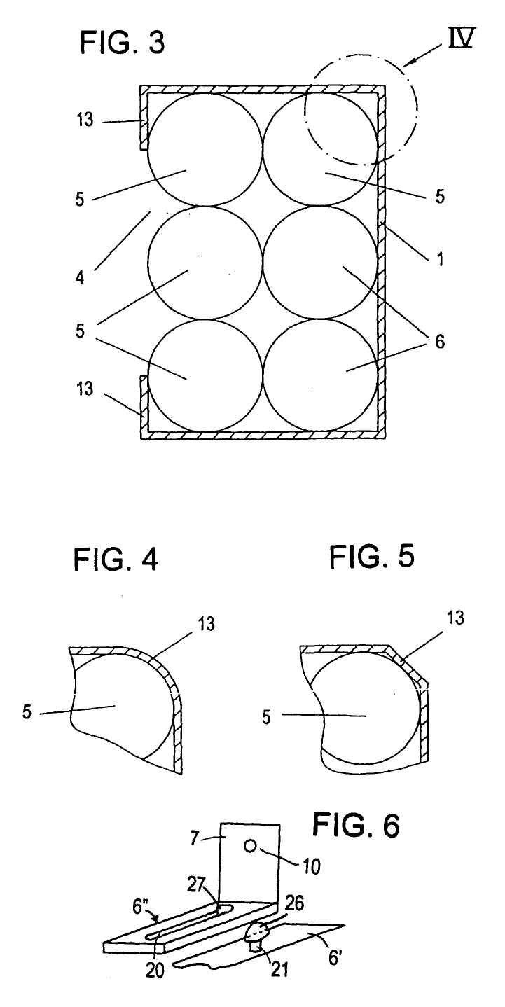

In the embodiment represented in FIG. 3, the duct 1 comprises legs 13 on the side that faces the wall 3, which extend from the corners toward the middle of the side and which effectuate a fixing of the lines 5 that are disposed in the duct prior to the fastening of the duct 1 to the wall 3 by means of the devises 6.

In order to fit the cross-section of the duct 1 to the lines 5 that are to be laid, the corners 13 can be rounded as represented in FIG. 4 or beveled as represented in FIG. 5.

The base plate 8 can be fastened to the wall centrally or on both ends. Threaded bars 22 for fastening the base plate 8 are inserted into the wall 3, namely being screwed into dowels 23. These threaded bars 22 protrude from the wall 3 and penetrate holes 24 in the base plate 8, whereby the base plate 8 is placed on the threaded bars 22 and then screwed down on the threaded bars 22 with the aid of nuts 25. In principle, the base plate 8 can also be fastened to the wall 3 with the aid of threaded screws that are screwed into the dowels 23.

FIG. 6 represents an embodiment of a pivoting and/or sliding fastening of the part 6″ of the clevis 6 to the part 6′. To that end, an elongated hole 20 with insertion opening 27 is constructed in the part 6″. A journal 21 is insertible into the elongated hole 20, which is provided with a terminal thickening 26 to prevent escape. The part 6″ can be shifted and/or pivoted relative to part 6′. The end of the elongated hole 20 that is remote from the fastening flange 7 is disposed at such a distance from the flange 7 that the journal 21 in the elongated hole 20 is pushed toward the wall 3, i.e. toward the flange 7, when the flange 7 is tightened on the base plate 8, so that the clevis 6 can be pressed against the duct 1 with a corresponding pressure.

It should be generally noted that the clevis 6 need not be precisely fitted to the duct 1; what is essential is merely that the dimensions of the duct and the clevis 6 parallel to the wall match; the legs of the U-shaped clevis 6 can be kept somewhat shorter than the corresponding legs of the duct 1, because a corresponding length compensation can be achieved, that is to say set, by means of shims or a similar spacer material.

An assembling of lines 5 with the aid of the inventive device is inventively achieved the following way:

A base plate 8 is mounted on the wall, and the clevis 6 is fastened to the base plate 8 with at least one flange 7, particularly the bottom flange. The devises 6 are advantageously fastened with both flanges 7 and the corresponding nuts 11.

In a next step, the part 6″ of the clevis 6 is opened, which is accomplished merely by unscrewing the top nut 11. The first line 5 is laid in the clevis 6, and the clevis 6 is closed again by screwing on the nut 11. This process is carried out for all devises 6 in succession.

Next, this process is repeated for the next line 5 to be laid, until all the lines 5 that are to be laid are received by the devises 6.

After the laying of the last line 5, the devises 6″ are closed by screwing on the nuts 11.

All lines 5 are laid this way.

The part 6″ in a first clevis is subsequently removed, i.e. opened, for purposes of installing the duct 1, and the duct 1 that was previously installed on the laid lines 5 is shifted or slid in under the open clevis 6. The final fastening of this clevis 6, specifically part 6″, can then occur.

Additional ducts 1 are then put in place, that is to say, installed on the lines 5, these being provided with—that is to say, joined by—sliding sockets given butt joints between the ducts, or, if there are end sockets on the ducts 1, the end sockets of a duct 1 about to be connected are placed onto the end of a duct 1 that has already been laid and fastened.

As soon as a duct 1 that is being laid is to be received again by a clevis 6, the clevis 6 is opened in the above described manner, and, after the placement thereof on the lines 5, the clevis is shifted under the open clevis 6.

An alternative course of action is to completely remove a clevis 6 by loosening the two nuts 11 after all lines 5 have been laid, whereby the laid lines 5 are fixed in position by the adjoining devises. Next, the duct 1 is slid onto the laid lines 5, whereupon the removed clevis 6 is re-fastened on the base plate by means of the nuts 11. The same procedure is followed for the adjoining devises 6, until the laid lines 0.5 are completely covered.

The length of a duct 1 advantageously corresponds to the distance between centers of two staggered devises 6.

We claim:

1. An assembly for fastening line material on a wall, comprising:
a duct for receiving the line material, said duct having an opening on a side facing the wall and remaining sides;
a plurality of devises for fastening said duct to the wall disposed at intervals in a longitudinal direction of said duct, said devises surrounding said duct on the remaining sides of said duct; and
said devises having protruding fastening flanges and including at least two interconnected parts joined to one another to enable said parts to be pivoted and/or shifted relative to one another.

2. The assembly according to claim 1, wherein said duct is configured to receive therein line material selected from the group consisting of pipes, hoses, and cables for mounting on interior sewer walls.

3. The assembly according to claim 1, wherein said duct has a U-shaped cross-section.

4. The assembly according to claim 3, wherein said U-shaped duct is formed with inwardly bent leg ends.

5. The assembly according to claim 1, which comprises a base plate to be disposed at and fixed to the wall of the structure, and wherein said flanges are detachably fastened to said base plate.

6. The assembly according to claim 5, which comprises bolts protruding from said base plate and penetrating through holes formed in said flanges.

7. The assembly according to claim 6, wherein said bolts are screw bolts.

8. The assembly according to claim 5, wherein said interconnected parts of said devises are pivotally connected about a pivot axis extending substantially perpendicular to the longitudinal direction of said duct and parallel to said base plate.

9. The assembly according to claim 1, wherein said interconnected parts of said devises are pivotally connected about a pivot axis extending substantially perpendicular to the longitudinal direction of said duct.

10. The assembly according to claim 1, wherein a first one of said parts is formed with an elongated hole and a second one of said parts carries a journal received by said elongated hole.

11. The assembly according to claim 1, wherein a side of said duct facing the wall is formed with legs extending from corners thereof toward a middle of the side, and wherein an opening between ends of said legs is kept clear for purposes of inserting the line material.

12. The assembly according to claim 1, wherein said duct comprises a plurality of portions adjoining one another at butt joints.

13. The assembly according to claim 1, wherein said duct comprises a plurality of portions formed with a sliding socket in one end region thereof, with said sliding socket slid over a corresponding end of a respectively adjoining duct.

14. The assembly according to claim 12, which comprises a socket joining said portions at said butt joints.

15. The assembly according to claim 1, wherein said duct has a polygonal cross section.

16. The assembly according to claim 15, wherein said polygonal cross section is defined with rounded, beveled, and/or square corners.

17. The assembly according to claim 1, wherein said duct has a rectangular cross section.

18. The assembly according to claim 17, wherein said rectangular cross section is defined with rounded, beveled, and/or square corners.

19. The assembly according to claim 1, wherein each of said devises has a U-shaped cross-section with legs of a U, and a flange protruding out from each end of said legs.
